(19) United States
(12) Patent Application Publication
(10) Pub. No.: US 2008/0274725 A1
(43) Pub. Date: Nov. 6, 2008

(54) Wireless multifunction network device

(76) Inventor: Ury George Tkachenko, Toronto (CA)

Correspondence Address: Ralph A. Dowell of DOWELL & DOWELL P.C., 2111 Eisenhower Ave, Suite 406, Alexandria, VA, 22314, US

(21) Appl. No.: 11/797,360

(22) Filed: May 2, 2007

(51) Int. Cl. H04Q 7/20

(52) U.S. Cl. 455/420

(57) ABSTRACT

The wireless multifunction network device includes a radio, first and second amplifier or filter devices, first and second antennae, a control system and a power module. The radio is adapted to support multiple protocols. The first amplifier or filter device is operably attached to the radio and is for processing a predetermined first frequency. The second amplifier or filter device is operably attached to the radio and is for processing a predetermined second frequency. The first antennae is operably attached to the first amplifier or filter device and is for use with the first frequency. The second antennae is operably attached to the second amplifier or filter device and is for used with the second frequency. The control system is operably attached to the radio. The power module is operably attached to the first amplifier or filter device, the second amplifier or filter device, and the control system.

### FIELD OF THE INVENTION

This invention relates to computer networks and in particular wireless computer networks.

### BACKGROUND OF THE INVENTION

The use of computers is almost ubiquitous. Computers appear to be everywhere. Further, in the fast-paced computer world there is a need to be on line. In order to meet this need wireless computer systems have been developed. Such wireless systems are found in many office towers, hotels, cafes and even in some city common spaces. However, the cost of setting up such networks is considerable. As well, a separate wireless network is typically installed for each specialized application (wireless voice over IP, streaming video, telemetry, general access) since each of the application has specialized network requirements.

The process of installing wireless networks with current products requires the services of specialized providers who resell, install, configure and support the required components. In many cases the system integrators are required to gather component parts from a variety of hardware and software vendors as there is no single source solution.

Integrators are required to estimate and then acquire adequate numbers of access points to complete a site survey. This survey will define the exact number and locations of access points required to provide sufficient wireless coverage. The access points will be moved numerous times until the best locations for each device is determined. The access points then have to be mounted, cabled and powered once the locations are identified.

The integrator then has to source, install and configure firewalls, intrusion detection systems, authentication servers, content filters, access lists and the network in general. The process of configuring the network security devices is extremely complex and time consuming.

The entire process is very labour intensive, prone to human error and requires many human resources such as network installer, electrician, network security specialist and others. These requirements increase the cost of installing the wireless networks. There are additional costs associated with supporting and maintaining the networks once they are installed.

Accordingly, it would be advantageous to provide a wireless network system that is easy to install. Further it would be advantageous to provide a wireless network system that includes more than one application such as wireless voice over IP, streaming video, telemetry, and general access.

### SUMMARY OF THE INVENTION

In one aspect of the invention a wireless multifunction network device comprising:

a radio adapted to support multiple protocols;

a first device being one of an amplifier and a filter, the first device being operably attached to the radio, the first device being for processing a predetermined first frequency;

a second device being one of an amplifier and filter, the device operably attached to the radio, the second device being for processing a predetermined second frequency;

a first antennae operably attached to the first device, the first antennae being for use with the first frequency;

a second antennae operably attached to the second device, the second antennae being for used with the second frequency;

a control system operably attached to the radio;

a power module operably attached to the first device, the second device, and the control system.

In another aspect of the invention there is provided a method of controlling access of a user to a network including the steps of:

determining if a packet associated with the user is allowed on the network;

if yes then determining if the packet matches an intrusion detection signature;

if no then determining if the user is accessing a virtual private network;

if yes, then determining if the user is allowed on the network;

if yes, then granting access to the network;

if the packet is not allowed on the network, then blocking the packet from accessing the wireless network and sending an access violation message to a system logging server;

if the packet matches an intrusion detection signature, then blocking the packet from accessing the network and sending an access violation message to the system logging server; and

if the user is not allowed on the network, then blocking the user from accessing the network and sending an access violation message to the system logging server.

In a further aspect of the inventionA method of controlling access of a user to a network including the steps of:

determining if the user is part of the loyalty program;

if yes then determining if the user has an account;

if yes then authenticating the user against an authentication/authorization/accounting server;

if yes, the granting access to the network;

if the user is not part of the loyalty program then reading USB security dongle associated with the user then authenticate the user for an allowed amount of time and sending the USB security data to a loyalty server and granting access to the network; and

if the user does not have an account then registering an account for the user in the authentication/authorization/accounting server to provide an updated authentication/authorization/accounting server and authenticating the user against an updated authentication/authorization/accounting server.

Further features of the invention will be described or will become apparent in the course of the following detailed description.

### BRIEF DESCRIPTION OF THE DRAWINGS

The invention will now be described by way of example only, with reference to the accompanying drawings, in which:

FIG. 1 is a perspective view of one embodiment of the housing of the wireless multifunction network device of the present invention;

FIG. 2 is a top view of the housing of FIG. 1;

FIG. 3 is a side view of the housing of FIG. 1;

FIG. 4 is a front view of the housing of FIG. 1;

FIG. 5 is a section view taken along A-A of FIG. 4

FIG. 6 is a front view of the wireless multifunction device of the present invention with one side of the housing removed;

FIG. 7 is a front perspective view of the side of the housing shown in FIG. 6;

FIG. 8 is a front view of the wireless multifunction device of the present invention similar to that shown in FIG. 6, but with the base plate removed;

FIG. 9 is a front perspective view of the side of the housing shown in FIG. 8;

FIG. 10 is a front view of one side of the base plate showing the components attached thereto;

FIG. 11 is a front view of the other side of the base plate showing the components attached thereto;

FIG. 12 is a front view of an alternate version of the other side of the base plate showing the components attached thereto;

FIG. 13 is a schematic representation of both sides of the base plate and showing the power cable connections;

FIG. 14 is a schematic representation of both side of the base plate and showing the connections to the radio and the antennas;

FIG. 15 is a schematic representation of the network of the present invention;

FIG. 16 is a schematic representation of a prior art system that would cover a similar area as the system shown in FIG. 15;

FIG. 17 is a flow chart showing the user interaction; and

FIG. 18 is a flow chart showing the system interaction.

### DETAILED DESCRIPTION OF THE INVENTION

The wireless network device of the present invention has three main applications. Specifically it can be used as an in-building wireless device; an out-building wireless meshing device; and a backbone/rural wireless meshing device. Each of the three applications may be comprised of and provide support for five elements. Preferably support of the five elements across the three applications allow for seamless roaming across the whole wireless network. These elements provide specialized functionality for five main network groupings as defined below. We refer to these five elements as STARC namely:
Surveillance—large data packets specifically used for any streaming data such as video. May include camera surveillance of: intersections, building, perimeters, parking lots, construction sites;
Telemetry—small data packets used for receiving status from telemetry devices such as dry contact systems and/or inventory management systems. May include: remote device management for HVAC, (heating ventilation and air conditioning) monitoring, electrical consumption;
Access—end user data traffic connecting to the Internet, Intranet, Extranet, VPNs, running office applications and/or Internet tools;
Responders—Licensed channel communication for public service responders including: EMS (emergency medical services), Fire, Police, Military; and
Communicators—Large data packets requiring QoS (Quality of Service) specifically for voice systems such as WVoIP (Wireless Voice over Internet Protocol).

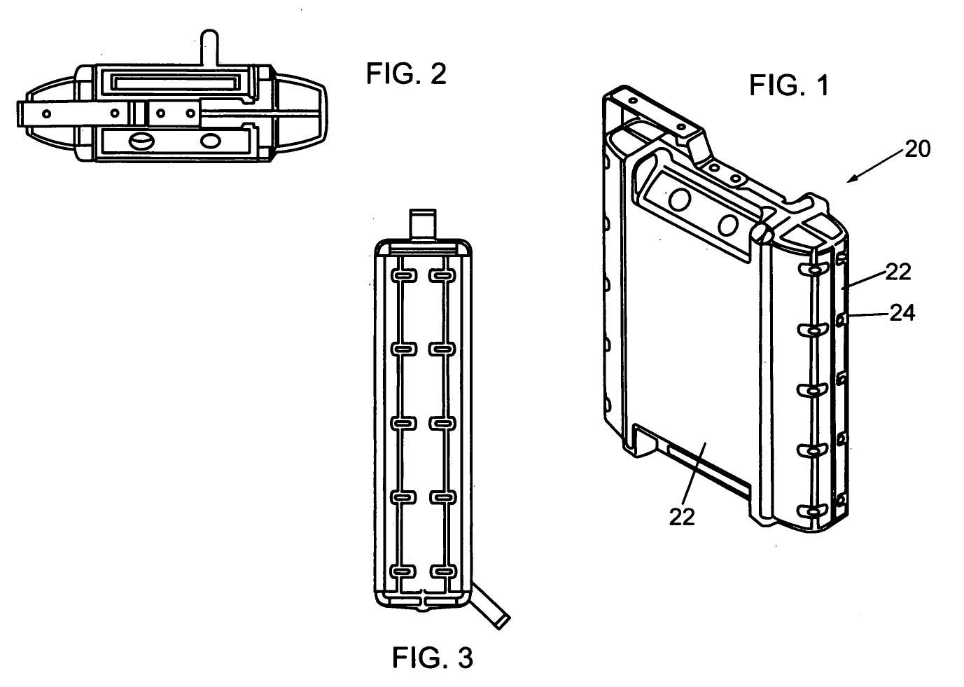

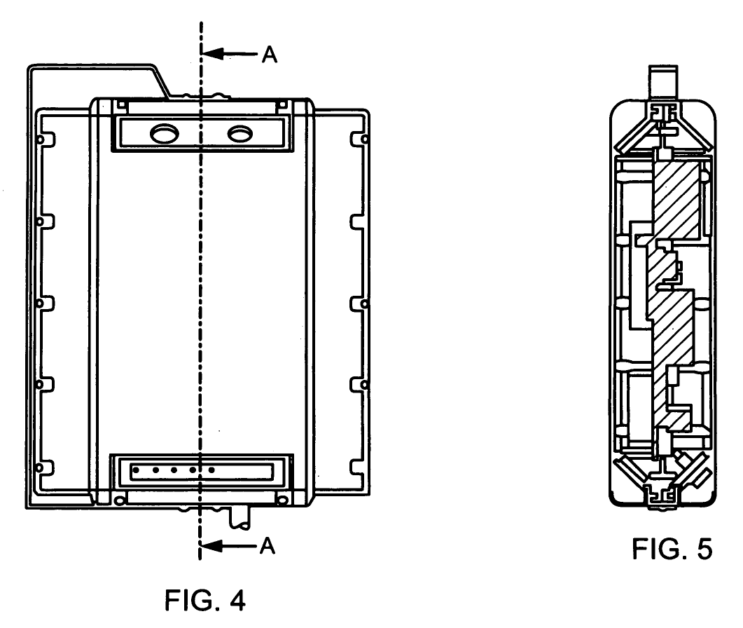

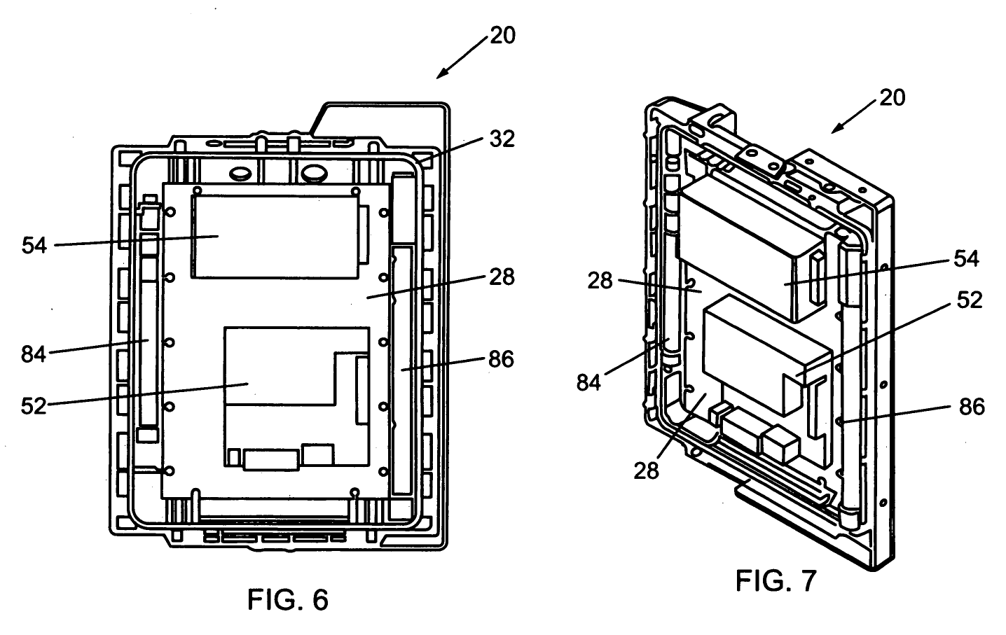

Referring to FIGS. 1 through 9, an embodiment of the wireless multifunction network device includes a sealed housing or unit 20 that may be installed indoors or outdoors depending on the application. The device shown and described herein can be used with each of the applications described above. The unit 20 may be wall, ceiling or pole mounted using the base mounting system. The housing is made of materials that provide sufficient protection to the products from the elements (weather, nature, manufacture environments, etc) and from tampering (users changing antennas and other components). The housing provides for connectivity to power sources (AC, solar), external wire based networks as well as telephony systems. The housing provides mounting points for all the components that comprise a complete system.

Preferably the housing 20 is made of high-impact, UV treated plastic. The plastic can be used both indoors and outdoors. It can withstand manufacturing environments as well as office and/or retail environments.

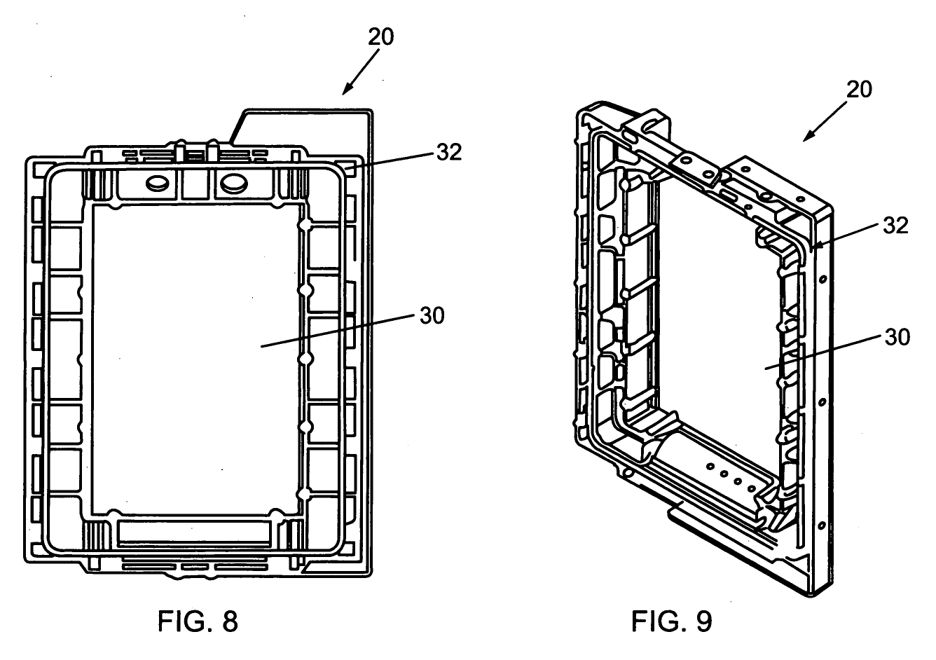

Preferably the housing 20 is made of two parts 22 being identical to each other, preferably the two parts are sealed with resin glue and then further re-enforced by using security nuts and bolts 24. The housing 20 provides enough space for power, network and telephony connectivity as well as on the outside area for logos, branding and certification stickers. One function of the housing 20 is to sandwich the base plate 28 and the two antennas 86 and 84 (see FIGS. 6 and 7) between the two halves, effectively pinning the components in place. The antennas 86 and 84 are located at opposite ends of the long edge of the housing while the base plate 28 sits between the two antennas 86 and 84. The base plate cavity 30 portion of the housing 20 is protected with a gasket 32 ensuring that water does not enter area housing the electronics (as best seen in FIGS. 8 and 9).

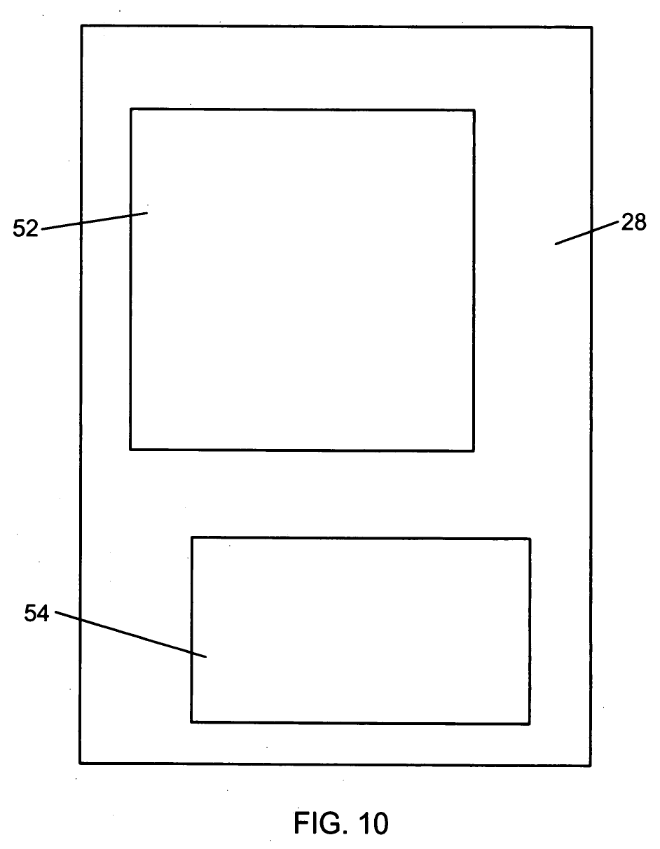

Referring to FIGS. 10 to 14, the components in the system are mounted on an aluminum plate. The plate provides for a stable, drillable and tap-able base. The aluminum provides shielding where required for the radio emitting devices.

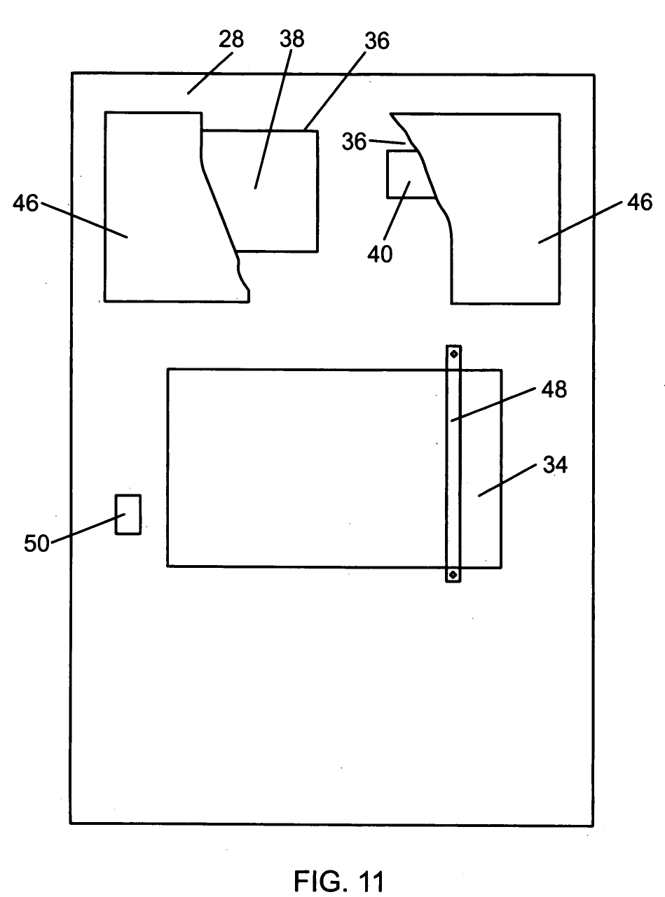

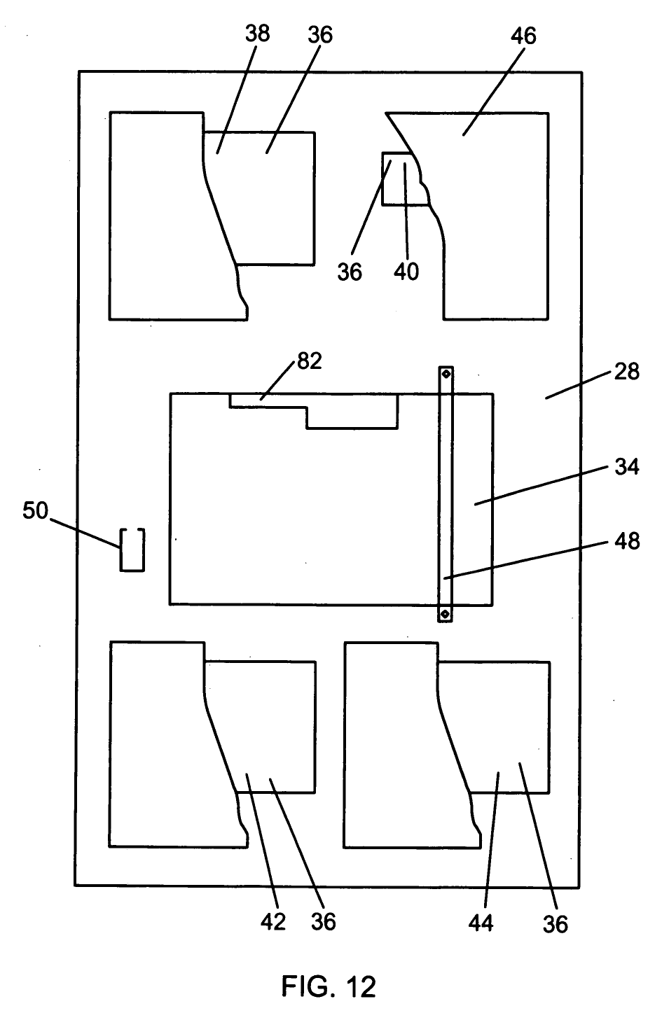

Components are attached to both sides of the plate 28 and alternate embodiments of one side or side A are shown in FIG. 11 and FIG. 12. Side A has all the radio related equipment attached thereto. The other side or side B as shown in FIG. 10 has all the computer related components attached to it.

In one embodiment side A of the base plate 28 is shown in FIG. 11. A radio 34 is attached to base plate 28. Preferably radio 34 is a multi-frequency radio that supports a number of different frequencies including 802.11a/b/g, first responder, Bluetooth and cellular frequencies. A plurality of amplifier/filters 36 are operably connected to the radio 34. As shown in FIG. 11, two amplifier/filers 36 are connected to the radio 34 and as shown in FIG. 12 four amplifier/filters 36 are connected to the radio 34. In FIG. 11 one amplifier/filters is an amplifier and filtering card for processing 802.11b/g frequencies 38 and the other is an amplifier and filtering card for process 802.11a and first responders frequencies 40. In FIG. 12 there are two additional amplifier/filters, specifically an amplifier and filtering card for processing Bluetooth frequencies 42 and an amplifier and frequency card for processing cellular frequencies 44. Each of the amplifier/filters is protected with enclosures 46 to prevent radio signal leakage. Preferably enclosures 44 are die-cast aluminum enclosures. A cable harness 48 is used to keep the radio cable connections in place. A DC-DC converter 50 is a step down DC voltage converter.

It will be appreciated by those skilled in the art that the amplifier/filter 36 device is a preferred embodiment. In certain application it may be possible to use only an amplifier or only a filter. For example where clarity of signal is the most important criteria only a filter may be used and where range of communication is the most important only an amplifier may be used. However, the preferred embodiment is to use a combination amplifier and filter device to enhance the clarity of signal and improve the range of communication.

The radio 34 that is installed will determine the functionality of the complete system. This radio may support 802.11b and g protocols, 802.11a protocols, first responders/homeland security protocols, Bluetooth protocols and cellular network protocols. Certain features may be disabled or enabled depending on the customers requirements and/or regulations in the area where the system is being installed.

The amplifier portion of the amplifier/filter devices 36 will increase the range of the radio frequencies that are operating. The amplifiers will also filter non-data related signals to ensure clear communication. These amplifier/filter devices 36 are off-the-shelf cards that are already FCC/UL/CSA/IC approved. The amplifier/filter devices 36 emit radio frequencies and as such need to be enclosed or shielded in aluminum housings.

The DC-DC converter 50 is a step down voltage converter that reduces 9 volts down to 5 volts. This device is required by some of the amplifier/filter devices 36.

Side B of the base plate 28 is shown in FIG. 10. A computer 52 and a power module 54 are attached to the base plate 28. The power module 54 is interchangeable to provide a variety of power options for the system. One power option will utilize AC power. The power source will output 3 DC voltages: 12 volt, −12 volt and 9 volt. The power source uses standard 120 volt, 15 amp wall jack power. The power source includes an computer power supply regulator and one AC/DC power converter. Another power option is to utilize DC power. The DC power may be provided by a Hydrogen Fuel Cell battery for remote applications or an optional Lithium Ion battery for vehicular applications. The third power option is to utilize DC power with a solar panel. The solar panel will be the charging source for Lithium Ion batteries.

Preferably Computer 52 is a standard off-the-shelf Pentium computer. The computer utilizes solid-state storage devices. These storage devices act as a standard hard drive where the operating system and other applications will be installed. The other applications will include: DNS, DHCP, SNMP monitoring, syslog, access control list, network routing protocols, wireless network meshing protocols, web services, firewalling, virtual private networking, intrusion detection, internet site access lists and configuration tools.

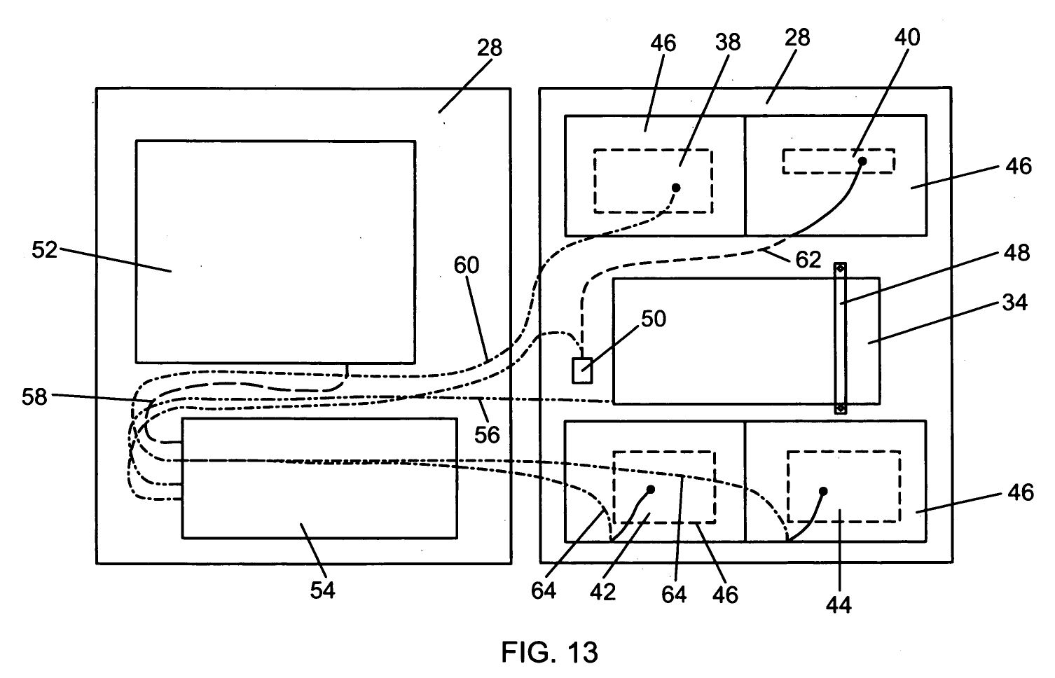

The cable connections between power module 54 and the various components are shown in FIG. 13. Specifically the radio 34 is connected to the power module 54 with a radio power cable 56. The computer 52 is connected to the power module 54 with a computer power cable 58. The DC-DC converter 50 is connected to the power module 54 with a converter power cable 60. The DC-DC converter is connected to an amplifier/filter device with a converter amplifier cable 62 if required. If the converter is not required the amplifier/filter device is connected to the power module 54 with an amplifier cable 64.

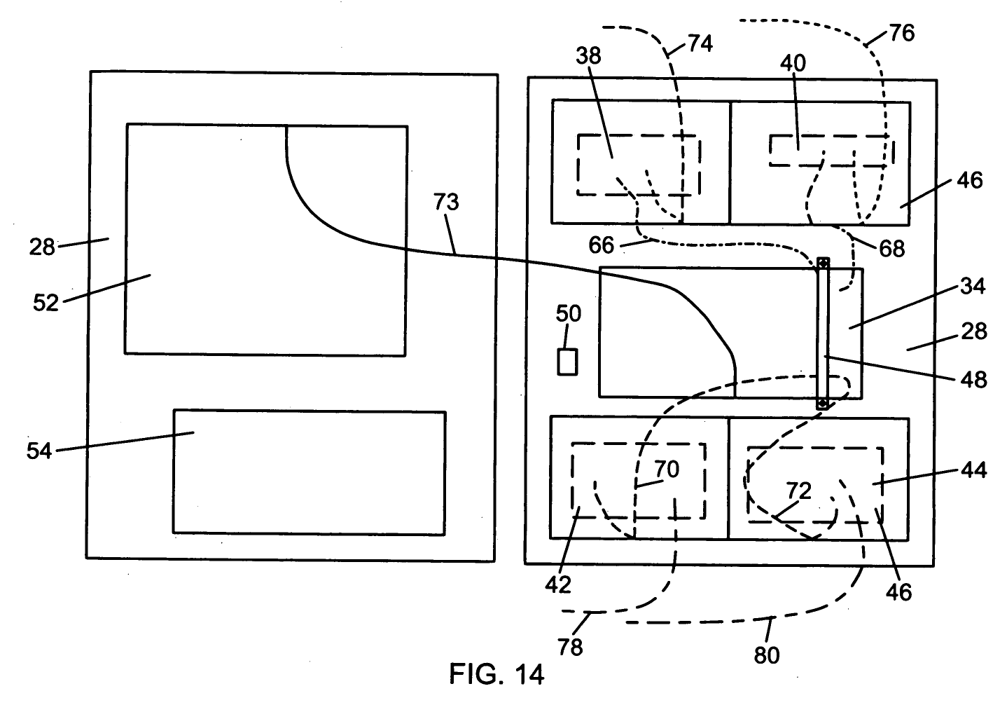

The connections between the radio 34 and the amplifier/filter devices 36 are shown in FIG. 14 as well as the connections to the antennae (not shown). The radio 34 is connected to each of the amplifier/filter devices 36. The amplifier/filter devices 36 shown in the embodiment herein include a 802.11b/g amplifier and filter device 38, a 802.11a amplifier and filter device 40, a Bluetooth amplifier and filter device 42 and a cellular amplifier and filter device 44. The connections will be described by way of example only with reference to these specific amplifier/filter devices however it will be appreciated by those skilled in the art that different amplifier and filter devices may be used. Specifically a b/g radio cable 66 connects the 802.11b/g amplifier and filter device 38 to the radio 34. An “a” radio cable 68 connects the 802.11a amplifier and filter device 40 to the radio 34. A Bluetooth radio cable 70 connects the Bluetooth amplifier and filter device 42 to the radio 34. A cellular cable 72 connects the cellular amplifier and filter device 44 to the radio 34. Each amplifier/filter device 36 is connected to an antenna (not shown) specific to the device 36. An 802.11b/g antenna cable 74 is connected between an 802.11b/g antenna and the 802.11b/g amplifier/filter device 38. An “a” antenna cable 76 is connected between an antenna and an “a” amplifier/filter device 40. A Bluetooth antenna cable 78 is connected between an antenna and a Bluetooth amplifier/filter device 42. A cellular antenna cable 80 is connected between an antenna and a cellular amplifier/filter device 44. The position of the antennae in a two antennae system that would correspond to the base plate 28 shown in FIG. 11 is shown in FIGS. 6 and 7. An 802.11b/g frequency antennae 84 and an emergency frequency antennae 86 are shown positioned at the edges of base plate 28 but within housing 22.

Optionally a fiber optic cables and LED cable harness 82 maybe used to attach fiber optic cables and LED display to visually display the status of the device as shown on FIG. 12.

The radio network connection 73 is attached to one of the network ports on the computer on the other side or side B.

The die-cast enclosures 46 for the amplifiers/filter devices 36 are screwed to the base plate 28 with machine screws, as is the DC-DC power converters 50. The radio and the bi-directional amplifiers/filter devices 36 are mounted with machines screws that screw into brass stand-offs that are screwed into the base plate. Paper isolation washers are used between circuit boards and points of contact with metal where required.

The hardware of the small board computer 52 is configured in the following manner; up to 2 GB RAM memory, up to 80 GB hard drive either as IDE flash disk and/or standard hard drive, two 10/100 Ethernet connections, one PCI riser card and one telephony card configured for supporting any of the various telephony connection such as: analog/digital RJ11 telephone cables, T1 or any other telephony inputs for Voice over IP telephony.

DC power is provided to the small board computer 52 by the AC/DC power converter. The AC/DC power converter is provided with 115 volt 15 Amp AC power from a standard grounded three pronged wall receptacle. The power converter has three DC outputs in the following configuration: two common and/or ground, one 9 volt, one 12 volt and one negative 12 volts.

The system of the present invention may include a number of components. Specifically it includes a 2.4 GHz antenna and/or antenna array, a 5 GHz Antenna and/or antenna array and a 4.9 GHz antenna and/or antenna array. These antenna and/or antenna arrays are operably connected to bi-directional amplifiers, specifically 2.4 GHz amplifier 38, 5.1 GHz amplifier and 4.9 GHz amplifier 40.

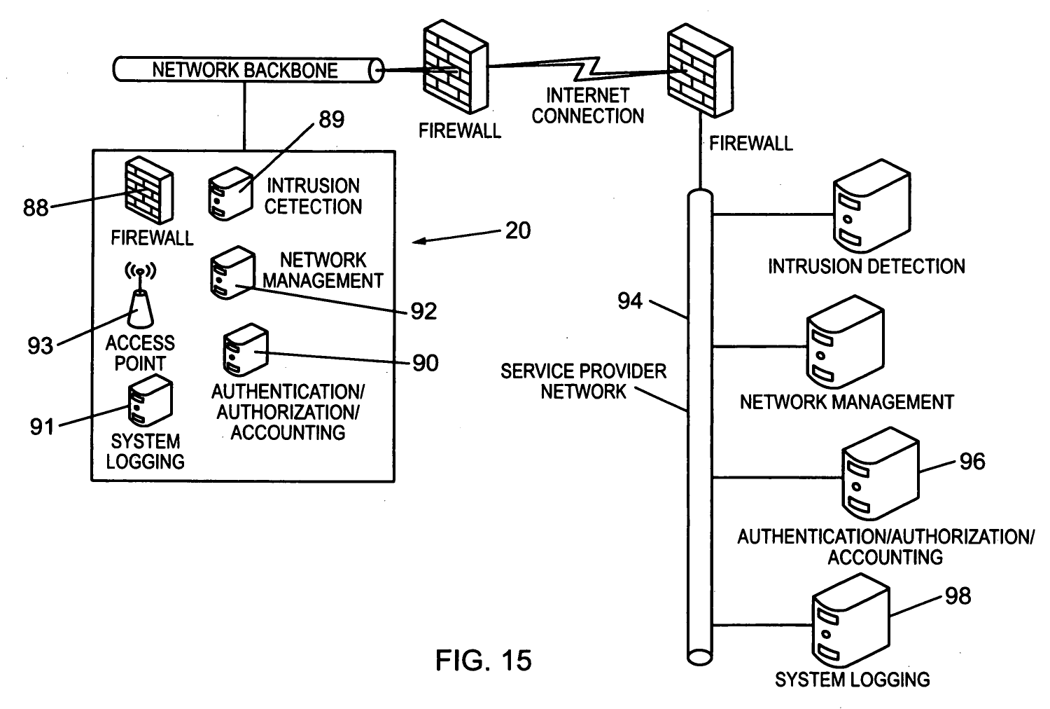

Computer 52 may include a number of functions or systems and this is graphically represented in FIG. 15. Specifically computer 52 includes a firewall/VPN (virtual private network) 88, intrusion detection 89, authentication/authorization/accounting 90, system logging 91, network management/monitoring 92. The network management/monitoring 92 could include such functions as proxy services/Content blocking and access control list.

The system also includes multi-band access point 93 for 802.11a/b/g frequency and public service 4.9 GHz frequency.

All hardware and software components that require configuration are preferably configured by means of browser-based tools. The devices have the ability to connect to the management service provider 94 upon first boot-up. Once the device is installed, connected to the network/Internet, the device preferably is immediately connected to a service provider for configuration to be completed. If a service provider is not used then the installer can complete the configuration on site with a laptop before the device is connected to the network/Internet. Where used, the service provider 94 not only configures the devices on initial boot-up but also maintains (enables upgrades), supports and monitors the devices. The service provider 94 may play the role of a network operation center.

It will be appreciated by those skilled in the art that the present invention may be realized in many different embodiments. For example the device may include two or more antennae and corresponding antennae and filter devices tuned to different predetermined frequencies. These frequencies may be as determined by the user. The frequencies chosen herein are by way of example only.

Each unit 20 may run and maintain a firewall 88. A basic rule set will be loaded onto each device, preferably the configuration will be updated to reflect each site specific requirements. Preferably, the updates are done remotely from the service providers site. The VPN feature, if enabled, may be configured by the service provider 94 on a per user basis.

Each unit 20 may run an intrusion detection 89 service to detect and proactively respond to attempts made by hackers and/or unauthorized users and/or unauthorized use of network services. Preferably the network signatures of unauthorized network services and/or hacking attempts are updated to the devices by the service provider. The intrusion detection system 89 may notify the appropriate individuals of any breaches and will also update the system logs at the service provider's site 94.

Each unit 20 may run and maintain a list of web content that is deemed inappropriate. The website chat services and/or mail servers that form part of such a list are blocked from being accessed by the users of the devices. Preferably if there are any attempts to by-pass the content filters a notification will be sent to the appropriate individuals and then be updated in the system logs at the service provider's site 94. These lists are maintained by the service provider 94 based on the customer profiles.

Each unit 20 may run and maintain an Authentication/Authorization/Accounting (AAA) 90 server and database, preferably this database is replicated to the master Authentication/Authorization/Accounting (AAA) server 96 at the service providers site 94. The master Authentication/Authorization/Accounting (AAA) server 96 will update the individual devices with larger databases depending on the profile for that device. The profiles may define who the customers are, what functions are enabled and what and how long the users are allowed to do on that particular device. A subsection of the AAA database is used to populate the master access control lists.

Each unit 20 may maintain an Access Control List of both users that are allowed to connect and of users that are denied connection. Preferably this list would be constantly updated by the service providers 94 master Access Control List (ACL). The master ACL is populated with the Media Access Control (MAC) addresses and usernames as they are registered on the Master Authentication/Authorization/Accounting (AAA) server. Any changes to the ACL on each device that are made outside of the master AAA 96 update process are logged in the System Logs for that unit. System logs are not stored on the unit 20. The system logging 91 is configured to store all system related logs on a centralized logging server 98 at the service provider's site 94. Each unit 20 is designated a name and stores its logs on the central server in a directory designated for that devices files.

Each unit 20 may be initially installed with a series of reserved SSID's (Service Set Identifier), and VLAN's (Virtual Local Area Network) for the purpose of network backbone, network monitoring, network maintenance and provide for cross network roaming. Each device is also configured with different Quality of Service (QOS) and MTU (Maximum Transmission Unit) settings to support the different STARC elements. The balance of the network configuration is done by the installer at the customers location. The network configuration will be provided to the installer by the network architect and/or network engineer responsible for the site.

Each unit runs a network management and monitoring tools 92 that updates the service providers Network Control center 94. This allows the service provider to proactively respond the network loads and respond to service outages. All alerts generated by the network management and monitoring tools 92 will be logged at the systems logs for that device.

The unit 20 may be configured to act as voice over IP (VOIP) PBX's (Private Branch Exchange) and will interconnect to telephony systems. These devices will interact with other devices to create a wireless VOIP (WVOIP) system. The non-PBX devices support WVOIP as part of the STARC framework. The PBX device will be able to; support voicemail boxes, support phone extensions and interact with external telephony systems. These PBX devices will be enabled, configured and supported by the service providers.

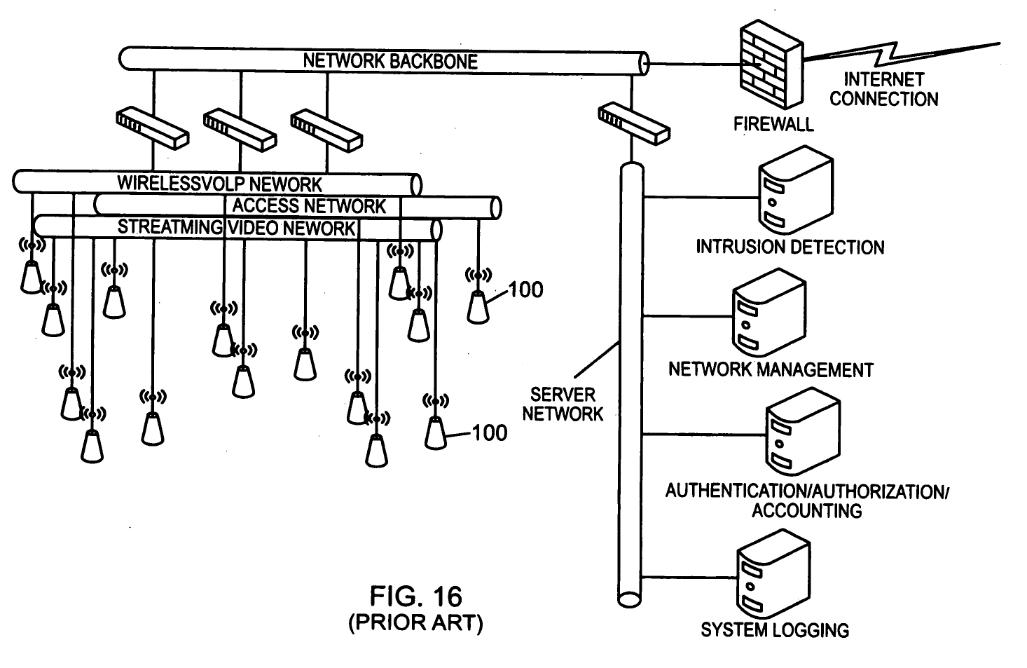

FIG. 16 shows the number of access points that are required for a prior art system. As can be seen a plurality of access points 100 are required with an existing system. Accordingly if the system of the present invention was installed in a warehouse or a big box type store where with an existing prior art system a number of access points would be required in the present system only one access point would be required.

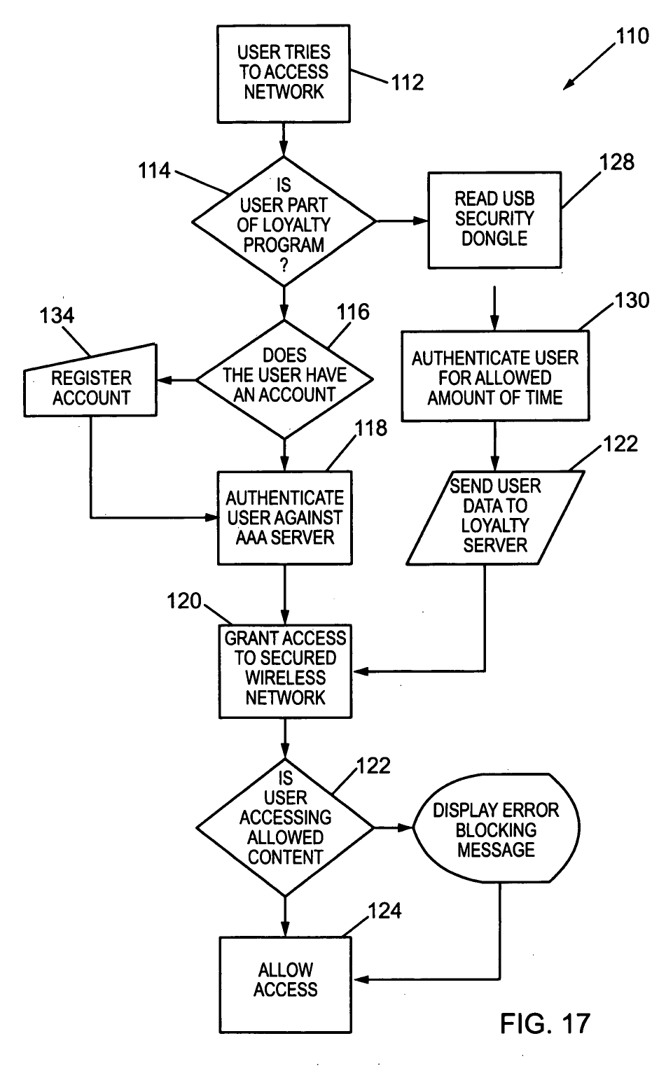

A flow chart of the user interface program is shown generally at 110 in FIG. 17. Firstly the user tries to interface with the network 112. The interface checks to determine if the user is part of the loyalty program 114 if yes then determine if the user has an account 116. If yes then authenticate the user against the AAA server 118. Once the user is authenticated access is granted to the secure wireless network 120. Determine if the user is accessing allowed content 122 and if yes then allow access 124.

If the user is not part of the loyalty program 114 then read the USB security dongle 128. Then authenticate the user for an allowed amount of time 130. Then send the user data to the loyalty server 132 and grant access to the secured wireless network 120.

In the event that the user does not have an account 116 then register the account 134. Then authenticate the user against the AAA server 118.

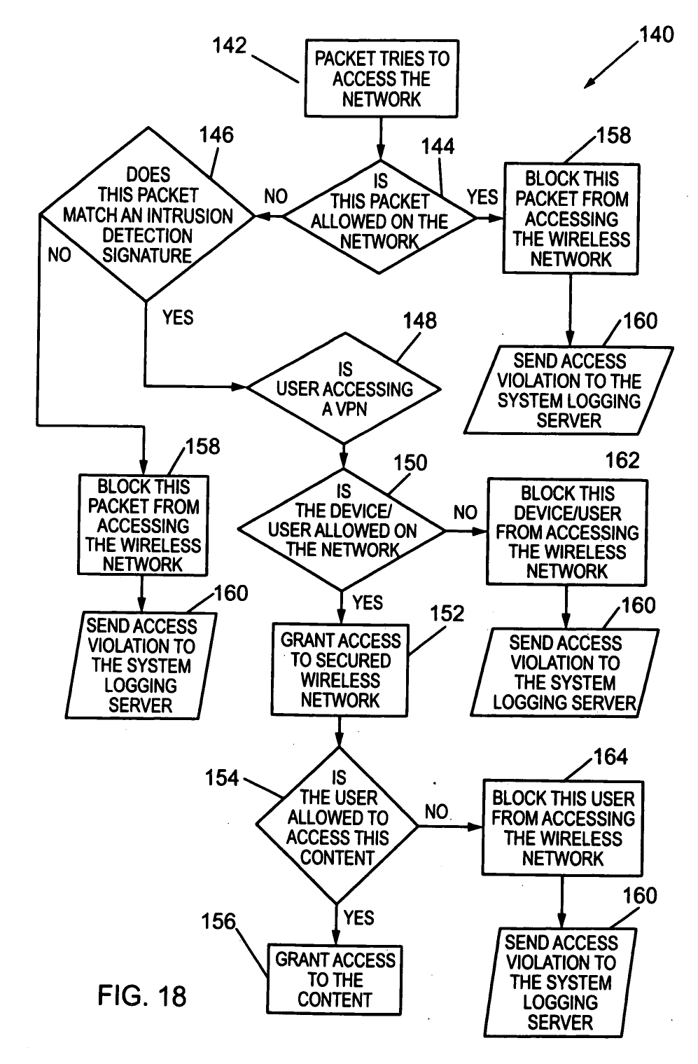

A flow chart of the system interaction is shown generally at 140 in FIG. 18. To initiate the process, the system or packet tries to access the network 142. A packet is a formatted block of information or data carried by a wireless or wire line computer network. Firstly it needs to be determined if the packet is allowed on the network 144. If yes does then this packet match an intrusion detection signature 146 and if no then determine if the user is accessing a VPN 148. If yes, then determine if the device or the user is allowed on the network 150. If yes, then grant access to the secured wireless network 152. Once on the network then determine if the user is allowed to access to particular content 154. If yes then grant access to the content 156.

If the packet is not allowed on the network 144, then block the packet from accessing the wireless network 158 and send the access violation to the system logging server 160.

If the packet matches an intrusion detection signature 146 then block the packet from accessing the wireless network 158 and send the access violation to the system logging server 160.

If the device or user is not allowed on the network 150 then block the device or user from accessing the wireless network 162 and send access violation to the system logging server 160.

If the user is not allowed to access particular content 154 then block the user from accessing the particular content on the wireless network 164 and send access violation to the system logging server 160.

As used herein, the terms “comprises” and “comprising” are to construed as being inclusive and opened rather than exclusive. Specifically, when used in this specification including the claims, the terms “comprises” and “comprising” and variations thereof mean that the specified features, steps or components are included. The terms are not to be interpreted to exclude the presence of other features, steps or components.

Generally speaking, the systems described herein are directed to a wireless multifunction network device and a system for using the same. As required, embodiments of the present invention are disclosed herein. However, the disclosed embodiments are merely exemplary, and it should be understood that the invention may be embodied in many various and alternative forms. The Figures are not to scale and some features may be exaggerated or minimized to show details of particular elements while related elements may have been eliminated to prevent obscuring novel aspects. Therefore, specific structural and functional details disclosed herein are not to be interpreted as limiting but merely as a basis for the claims and as a representative basis for teaching one skilled in the art to variously employ the present invention. For purposes of teaching and not limitation, the illustrated embodiments are directed to a wireless multifunction network device.

What is claimed as the invention is:

1. A wireless multifunction network device comprising:
a radio adapted to support multiple protocols;
a first device being one of an amplifier and a filter, the first device being operably attached to the radio, the first device being for processing a predetermined first frequency;
a second device being one of an amplifier and filter, the device operably attached to the radio, the second device being for processing a predetermined second frequency;
a first antennae operably attached to the first device, the first antennae being for use with the first frequency;
a second antennae operably attached to the second device, the second antennae being for used with the second frequency;
a control system operably attached to the radio;
a power module operably attached to the first device, the second device, and the control system.

2. A wireless multifunction network device as claimed in claim 1 wherein the first device is both an amplifier and a filter.

3. A wireless multifunction network device as claimed in claim 2 wherein the second device is both an amplifier and a filter.

4. A wireless multifunction network device as claimed in claim 3 wherein the first frequency is an 802.11 GHz b/g frequencies.

5. A wireless multifunction network device as claimed in claim 4 wherein the second frequency is an 802.11a GHz frequency.

6. A wireless multifunction network device as claimed in claim 4 wherein the second frequency is a first responder frequency.

7. A wireless multifunction network device as claimed in claim 1 wherein the power module is connected to a standard 120 volt service.

8. A wireless multifunction network device as claimed in claim 1 further including a third device being one of an amplifier and a filter, the third device being operably attached to the radio and a third antennae operably attached thereto, the third device being for processing a predetermined third frequency and the third antennae being used with the third frequency.

9. A wireless multifunction network device as claimed in claim 8 wherein the fourth device is both an amplifier and a filter.

10. A wireless multifunction network device as claimed in claim 9 further including a fourth amplifier and filter device operably attached to the radio and a fourth antennae operably attached thereto, the fourth amplifier and filter device being for processing a predetermined fourth frequency and the fourth antennae being used with the fourth frequency.

11. A wireless multifunction network device as claimed in claim 4 further including a third amplifier and filter device operably attached to the radio and a third antennae operably attached thereto, the third amplifier and filter device being for processing a Bluetooth frequency and the third antennae being used with the Bluetooth frequency.

12. A wireless multifunction network device as claimed in claim 8 further including a fourth amplifier and filter device operably attached to the radio and a fourth antennae operably attached thereto, the fourth amplifier and filter device being for processing a cellular frequency and the fourth antennae being used with the cellular frequency.

13. A wireless multifunction network device as claimed in claim 1 wherein the power module is a DC power source.

14. A wireless multifunction network device as claimed in claim 10 wherein the DC power source is a hydrogen fuel cell battery.

15. A wireless multifunction network device as claimed in claim 10 wherein the DC power source is a lithium ion battery.

16. A wireless multifunction network device as claimed in claim 12 wherein the power source is operably connected to a solar panel capable of recharging the lithium ion battery.

17. A wireless multifunction network device as claimed in claim 1 wherein the control system is a computer.

18. A wireless multifunction network device as claimed in claim 14 wherein the computer includes a plurality of different applications.

19. A wireless multifunction network device as claimed in claim 15 wherein the applications are chosen from the group consisting of monitoring applications, syslog, access control list, network routing protocols, wireless network meshing protocols, web services, firewalling, virtual private networking, intrusion detection, internet site access lists and configuration tools.

20. A wireless multifunction network device as claimed in claim 1 further including a housing.

21. A wireless multifunction network device as claimed in claim 17 wherein the housing is sealed and tamperproof.

22. A wireless multifunction network device as claimed in claim 18 wherein the housing is waterproof.

23. A method of controlling access of a user to a network including the steps of:
determining if a packet associated with the user is allowed on the network;
if yes then determining if the packet matches an intrusion detection signature;
if no then determining if the user is accessing a virtual private network;
if yes, then determining if the user is allowed on the network;
if yes, then granting access to the network;
if the packet is not allowed on the network, then blocking the packet from accessing the wireless network and sending an access violation message to a system logging server;
if the packet matches an intrusion detection signature, then blocking the packet from accessing the network and sending an access violation message to the system logging server; and
if the user is not allowed on the network, then blocking the user from accessing the network and sending an access violation message to the system logging server.

24. A method of controlling access to a network as claimed in claim 20 further including the steps of determining if the user is allowed to access to particular content; if yes then granting access to the content and if no then not allowing access to particular content, blocking the user from accessing the particular content on wireless network and sending an access violation message to the system logging server.

25. A method of controlling access to a network as claimed in claim 21 wherein the network is a wireless network.

26. A method of controlling access of a user to a network including the steps of:
determining if the user is part of the loyalty program;
if yes then determining if the user has an account;
if yes then authenticating the user against an authentication/authorization/accounting server;
if yes, the granting access to the network;
if the user is not part of the loyalty program then reading USB security dongle associated with the user then authenticate the user for an allowed amount of time and sending the USB security data to a loyalty server and granting access to the network; and
if the user does not have an account then registering an account for the user in the authentication/authorization/accounting server to provide an updated authentication/authorization/accounting server and authenticating the user against an updated authentication/authorization/accounting server.

27. A method of controlling access to a network as claimed in claim 20 further including the steps of determining if the user is attempting to access allowed content and if yes then allowing access and if no then denying access.

28. A method of controlling access to a network as claimed in claim 21 wherein the network is a wireless network.
